(19) United States
(12) Patent Application Publication
(10) Pub. No.: US 2017/0336343 A1
(43) Pub. Date: Nov. 23, 2017

(54) INTEGRATED SENSING DEVICE FOR DETECTING GASSES

(71) Applicant: InSyte Systems, Newark, CA (US)

(72) Inventors: Jerome Chandra Bhat, Palo Alto, CA (US); Richard Ian Olsen, Truckee, CA (US)

(21) Appl. No.: 15/598,228

(22) Filed: May 17, 2017

Related U.S. Application Data
(60) Provisional application No. 62/338,900, filed on May 19, 2016.

(51) Int. Cl. G01N 27/406; G01N 27/416; G01N 27/407

(52) U.S. Cl. CPC G01N 27/4065; G01N 27/4073; G01N 27/4163

(57) ABSTRACT

An electrochemical gas sensing element has a footprint of less than 5 mm×5 mm so the volume of electrolyte, the sizes of the electrodes, and the electrical interconnects are very small. This results in a fast stabilization after detecting gasses and enables rapid changes in bias voltage to target different gasses. The sensor body is ceramic, and the other components are stable at temperatures including solder reflow temperatures, thus allowing the use of conventional solder reflow techniques to mount the sensing element to a PCB. A sensor circuit is mounted on the sensing element body to detect the currents through the sensor electrode and digitally process the information, resulting in a more accurate analysis. The small size, low power consumption, and modularity allow the sensor element to be mounted in small handheld devices.

### CROSS-REFERENCE TO RELATED APPLICATIONS

This application is based on and claims priority from U.S. provisional patent application Ser. No. 62/338,900, filed on May 19, 2016, by Jerome Chandra Bhat and Richard Ian Olsen, assigned to the present assignee and incorporated herein by reference.

### FIELD OF THE INVENTION

This invention relates to the sensing and identification of low density materials, such as gasses, and, in particular, to the sensing and identification of low density materials by an electrochemical cell in conjunction with a sensing circuit.

### BACKGROUND

Given the dramatic changes in the earth's atmosphere, precipitated by industrialization and natural sources, as well as the dramatically increasing number of household and urban pollution sources, the need for accurate and continuous air quality monitoring has become necessary to both identify the sources and warn consumers of impending danger. Tantamount to making real-time monitoring and exposure assessment a reality is the ability to deliver, low cost, small form factor, and low power devices which can be integrated into the broadest range of platforms and applications.

There are multiple methods of sensing distinct low density materials such as gasses. Common methods include nondispersive infrared spectroscopy (NDIR), the use of metal oxide sensors, the use chemiresistors, and the use of electrochemical sensors. The present invention pertains to electrochemical sensors. The principle of operation of an electrochemical sensor is well known and is summarized in the following overview: http://www.spec-sensors.com/wp-content/uploads/2016/05/SPEC-Sensor-Operation-Overview.pdf, incorporated herein by reference.

Basically, in an electrochemical sensor, a sensor electrode (also known as a working electrode) contacts a suitable electrolyte. The sensor electrode typically comprises a catalytic metal that reacts with the target gas and electrolyte to release or accept electrons, which creates a characteristic current in the electrolyte when the electrode is properly biased and when used in conjunction with an appropriate counter-electrode. The current is generally proportional to the amount of target gas contacting the sensor electrode. By using a sensor electrode material and bias that is targeted to the particular gas to be detected and sensing the current, the concentration of the target gas in the ambient atmosphere can be determined.

One drawback with a conventional electrochemical sensor is that its size (e.g., volume of electrolyte and size of electrodes) is relative large so that it takes a long time to stabilize when subjected to the target gas. Further, since the change in current in response to a gas is small, there is a low signal to noise ratio, and there are losses and RF coupling due to metal traces leading to processing circuitry external to the sensor, further reducing the signal to noise ratio. Additionally, the electrochemical cell body is typically a polymer that cannot withstand temperatures above 150° C., and the electrolyte comprises an aqueous acid that cannot withstand temperatures above approximately 100° C. This prevents the electrical contacts from being soldered to a printed circuit board by reflowing the solder (typically at 180-260° C.) and prevents the used of some heat-cured conductive adhesives such as silver-containing epoxies, or anisotropic conductive films or pastes (typically at cured at 120-150° C.).

Accordingly, what is needed is an electrochemical sensor for gasses that does not have the drawbacks of the conventional sensor.

### SUMMARY

The following outlines an electrochemical sensor architecture which achieves the basic requirements of selectively identifying specific gases in the presence of diverse atmospheres, small form factor, and low power. A method whereby networked sensors are calibrated on an ongoing basis is further outlined.

There are four basic novel elements in one embodiment of the invention. The first is the structural component which comprises the mechanical platform, in and upon which various functional components are attached. The structure forms a mechanical module which allows for multiple layers of components which may include but are not limited to filters, containment structures, electrodes, fluid containment, solid containment, electrical interconnects, semiconductor die and attachment structures such as solder balls or gold (or other metal) stud bumps. Layers of ceramic and metal bonded together form both a mechanical topology, as well as the electrical interconnects for both the electronic and electro-chemical subsystems. Additional non ceramic layers can also be overlaid onto the ceramic base to add functionality with regards to gas filtering, water resistance, and thermal imaging. Connection to other components in the system also are integrated into the mechanical platform via interconnect methodology applied to, for instance, the bottom, sides, or top of the structure.

Since the body of the electrochemical sensor is a ceramic, such as alumina, it can withstand temperatures in excess of the solder flow temperature (e.g., 260° C.). Further, the electrodes and non-aqueous electrolyte can also withstand solder reflow temperatures. Additionally, the footprint of the sensor may be as small as 4 mm×4 mm, with a height about 2 mm. Therefore, the volume of the electrolyte and size of the electrodes are very small. This results in a very fast reaction and stabilization time when the sensor is subject to the target gas, such as less than one second.

The second element is the electro-chemical (EC) cell. The EC cell is functionally comprised of specific combinations of electrodes, catalysts, and electrolytes. Electrodes are placed onto the lid of the structural platform in a specific configuration to allow for current flow in the presence of the catalyst and a reactant gas. The lid has one or more apertures to allow gas to inter-react with the catalyst. Alternatively, one or more apertures may be incorporated into the base. One or more EC cells can be supported in a single structural platform. Therefore multiple gas detection can be accommodated through either multiple cells or through the modification of the electrode bias controlled by the electronic subsystem. The electrodes are then interconnected with analog and digital subsystems which amplify and then convert the signal characteristic of the inter-reaction into a digital representation of the signal. Integral to the EC cell is a specific, optional filter material which can, as an example, exclude volatile organic compound gases from entering the cell. Likewise, hydrophobic filters can, as a further example, exclude water from entering the cell.

By providing a very small volume of the electrolyte and small electrodes, a change in bias voltage to tailor the sensor to a different target gas results in a rapid change in the characteristics of the sensor. Thus, a broad range of gasses may be detected within a short time. In some applications, a fast reaction time may be necessary, such as for a breath test.

The third element is the electronic processing of the output signal of the EC cell as well as the interface with other system components outside of the sensor module. As mentioned above, the signal induced onto the electrode passes through amplification and noise reduction circuits which are then converted from an analog signal to a digital representation of the signal level. The raw digital signal can now be stored in the memory of the electronic subsystem (ES) and can either be sent through a standard interface, such as I2C, or processed locally in the module. Control of the electrode bias can also be controlled automatically by the ES or externally through the system interface or, if required, by a separate input signal. Threshold annunciation via, for example, an interrupt signal, or calibration cycles can also be managed and performed by the ES.

In a preferred embodiment, the processing circuitry is a chip affixed to the bottom of the sensor. Thus, there is very little loss and RF coupling due to small traces leading from the electrodes to the current detection circuitry. Further, a temperature sensor in the chip accurately measures the temperature of the sensor since it is directly attached to the sensor. Additionally, since the sensor and processing circuitry form a single module with a footprint of about 4 mm×4 mm, it can easily be provided in a handheld device.

These three elements form all of the functional blocks used to detect, translate and report the presence of and the concentration of specific gases. Added functionality can easily be added to the structural component in the form of added sensors such as, but not limited to, temperature sensors (both contact and non-contact), air pressure sensors (both contact and non-contact), and humidity sensors. Added functionality can also be provided to the ES through additional circuits to process parallel or sequential readings of additional functions.

A fourth element of this embodiment comprises the networking of multiple sensors of know fixed or moving locations to allow ongoing calibration of the sensors. In this scheme, networking of two or more sensors along with knowledge of the geographic location of those sensors and the time at which the sensors are sampling the environment allows the readings of the two of more sensors to be compared, and for the less-recently-calibrated or worse-calibrated of the sensors to be recalibrated based on the data from the other sensors in its vicinity. The digital output of the processing circuitry in the sensor module may be transmitted by RF or the Internet to a remote central network for monitoring the outputs of the network of sensors. The sensor may also be remotely controlled to detect a wide range of different gasses of interest. The detection from dispersed sensors may be processed by the network to determine the source of a particular gas and to detect the effects of the environmental conditions on the gas.

Uses of the sensor module include detection of air quality (e.g., carbon monoxide), gas exposure control, toxic gas detection, breath analysis, feedback in industrial processes, etc.

Other embodiments and advantages are described.

### BRIEF DESCRIPTIONS OF DRAWINGS

FIG. 1 is a cross-sectional view of an embodiment of a sensor module, in accordance with one embodiment of the invention, comprising a cavity package, electrodes, an electrolyte, a sensing circuit, and electrical interconnects.

FIG. 2 illustrates the sensor module of FIG. 1 in which a temporary protective cover has been placed over the opening to protect the electrodes from poisoning during processing.

FIG. 3 is an exploded perspective view of a sensor module similar to that of FIG. 1.

FIG. 4 illustrates one of many different types of circuits that may be used to bias the electrodes and detect the current flow.

FIG. 5 is a geographic representation of a network of interconnected sensors.

FIG. 6 is a flowchart of a technique to accurately calibrate all sensors in a network.

FIG. 7 is a flowchart of a technique to assess the impact of environmental factors, such as temperature and humidity, on the gasses sensed by the network of sensors.

Elements that are the same or equivalent in the various figures are labeled with the same numeral.

### DETAILED DESCRIPTION

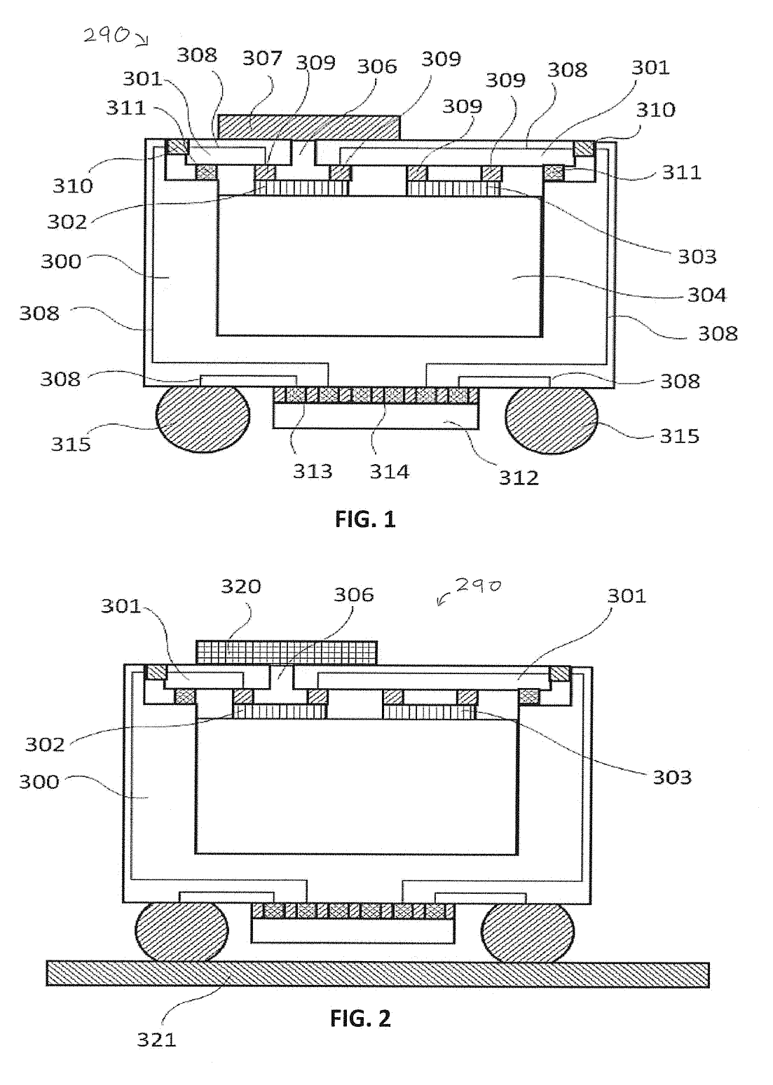

FIG. 1 illustrates a best mode embodiment of an electrochemical sensor module 290. The electrochemical sensor module 290 comprises a cavity-containing body 300 and a lid 301. Two or more electrodes 302/303 are attached to or integrated into the body 300 or the lid 301. An electrolyte 304 is dispensed into the cavity of the body 300 and is in contact with the electrodes 302/303. In certain embodiments, the electrolyte 304 may be integrated with the electrodes 302/303.

A full or partial opening 306 exists within either the body 300 or the lid 301 to allow diffusion of the gas or atmosphere being sensed to the working electrode (WE) 302. In certain embodiments, the opening 306 is partially or fully filled with an optionally porous material which can allow gas to diffuse to the electrode 302, but can block liquid or paste-like electrolyte from exiting the cavity.

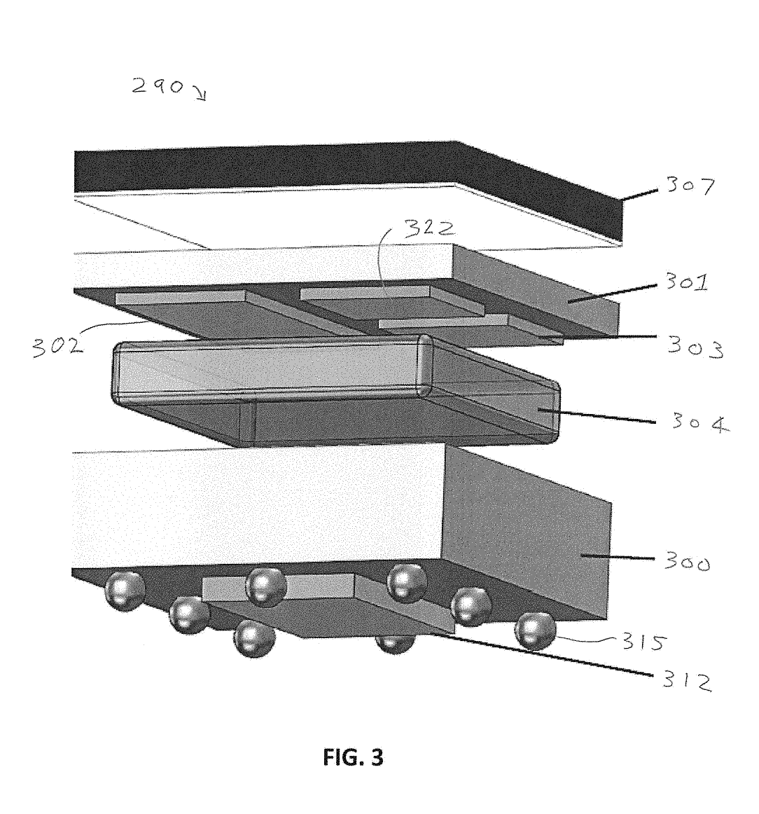

A counter electrode (CE) 303 is provided in the system to allow the electrochemical reaction to occur. A third reference electrode (RE) may optionally be included against which the electrical potential of the WE 302 and CE 303 may be measured. The reference electrode (RE) 322 is shown in FIG. 3

Electrochemical cells are sensitive to a multitude of gasses. Accordingly, in some embodiments, a filter material 307 is placed on the outside of the electrochemical cell over the opening 306 to inhibit the passage of certain gasses to the WE 302, thereby reducing the cross sensitivity of the cell between certain gasses. The filter material 307 may comprise a porous material such as carbon or a zeolite. In certain embodiments, the filter material 307 may be chemically functionalized.

The body 300 and the lid 301 comprise a material which is inert to the electrolyte 304. The body 300 and the lid 301 further allow transport of isolated electrical signals (currents and potentials) between the WE 302, CE 303, optional RE, and the outside of the electrochemical cell by way of integrated electrically-conducting traces 308. In preferred embodiments, these traces 308 are electromagnetically shielded so as to minimize the pick-up of stray electromagnetic radiation by the traces 308. Shielding may be by surrounding the traces 308 with a grounded metal enclosure.

In a preferred embodiment, the body 300 comprises a ceramic such as alumina or aluminum nitride, or a glass-ceramic, co-fired with metallic traces 308 such as tungsten, platinum or any other appropriate conductive material allowing passage of electrical signals through or around the package body 300. At any point that the conducting traces 308 emerge on the interior or exterior of the package, they may be further plated with additional metals such as a stack of nickel and gold.

The electrodes 302/303/322 comprise an electrically conducting material such a carbon and a catalyst such as ruthenium, copper, gold, silver, platinum, iron, ruthenium, nickel, palladium, cobolt, rhodium, iridium, osmium, vanadium, or any other suitable transition metal. The catalyst may be selected so as to preferentially sense one or more particular gases. The electrodes 302/303/322 may be partially permeable to both the electrolyte 304 and the gas to be detected so that the electrochemical reaction may occur within the body of the electrodes 302/303/322. The electrodes 302/303/322 are preferentially both physically and chemically stable to temperatures above 160° C. or more, preferably above 260° C. for an extended period of time so as to allow the electrochemical cell to be processed at elevated temperatures during assembly, such as for solder reflow.

The electrodes 302/303/322 may be attached to the package traces 308 via a conducting adhesive 309 having chemical resistance to the electrolyte 304. In a preferred embodiment, any conducting elements within the adhesive 309 would play no role in any electrochemical reaction occurring under normal operating conditions within the package. Such a conducting element may comprise carbon, a highly conducting semiconductor, or a non-catalytic metal. In another preferred embodiment, the conducting elements comprise the same metal as the catalyst incorporated into the electrode 302/303. In this way, electrochemical reactions occurring at the electrodes 302/303 and at the surface of the adhesive 309 occur at the same electrochemical potentials. In an alternative embodiment, the electrodes 302/303/322 may be directly deposited onto the lid 301 or body 300 of the cavity package without additional adhesive.

The electrolyte 304 comprises an ionic material such as an acid. In a preferred embodiment, the electrolyte 304 is both physically and chemically stable to temperatures above 160° C., or more preferably above 260° C. for an extended period of time. This allows the electrochemical cell to be processed at elevated temperatures during assembly and allows the sensor module bottom contacts to be soldered to substrate pads by solder reflow. One class of electrolyte materials being both ionic and chemically/physically stable at high temperatures comprise zwitterionic materials. A preferred embodiment uses a zwitterionic material as an electrolyte 304. A zwitterionic material is a neutral material with both positive and negative electrical charges. The electrolyte 304 may be viscous such as a gel. A second preferred embodiment comprises a polymer infused with an organic or inorganic acid. In this case, the polymer may act to stabilize the infused acid to temperatures of above 160° C., or more preferably above 260° C. for an extended period of time.

In a preferred embodiment, the lid 301 and the body 300 of the package are sealed together with a seal 311. The seal 311 may comprise an organic adhesive having chemical resistance to the electrolyte, such as an epoxy, a silicone, or an acrylic. The seal 311 may alternatively comprise an inorganic material such as a frit glass. Additionally, in the case that one or more of the electrodes 302/303/322 is connected to the lid 301, electrical connections between the traces 308 in the lid 301 and in the body 300 may be made by way of electrical interconnects 310. These electrical interconnects 310 may comprise a metal such as a solder, a conducting adhesive such as a silver-containing epoxy, gold-containing epoxy, carbon-containing epoxy, or any other appropriate electrical contact.

The electrical traces 308 within the package allow for electrical connection between the electrodes 302/303/322 and an analog or mixed-signal sensing circuit 312. The sensing circuit 312 may comprise an application-specific integrated circuit (ASIC) or multiple ICs, such as an ASIC and a microprocessor. The sensing circuit 312 is capable of applying electrical potentials between the CE 303, WE 302, and optional RE 322, sensing electrical currents passing between the WE 302, CE 303, and optional RE 322, and reporting on the sensed signals. In its simplest form, the sensing circuit 312 comprises a potentiostat for enabling functioning of the electrochemical cell, one or more trans-impedance amplifiers for measuring the currents passing between the electrodes, and a variable-bias voltage source for applying potential between the electrodes. In a preferred embodiment, the sensing circuit 312 comprises an analog front-end (AFE) to which the electrochemical cell is connected, an analog-to-digital converter (ADC) capable of converting the sensed signals between the electrodes into a digital representation, a digital-to-analog converter (DAC) by which the electrochemical potentials between the electrodes may be set from a digital representation, digital control circuitry, registers, and a communications interface such as an I2C interface, SPI interface, or a MIPI interface. Optionally, the sensing circuit 312 may also include a microprocessor on which algorithms may be stored and executed enabling, for example, reporting out of calibrated gas concentrations. Alternatively, the microprocessor may be integrated onto the package in the form of a second, discrete component.

The sensing circuit 312 may further comprise one or more of an integrated temperature sensor, an integrated humidity sensor, and an integrated air pressure sensor. Alternatively, the sensing circuit 312 may comprise only the AFEs required to sense humidity, temperature and pressure via external components. Any sensing circuit 312 incorporating such analog circuitry would additionally comprise ADCs and DACs and digital circuitry required to operate with the extended AFE, or multiplexing circuitry to allow the ADCs and DACs to selectively connect to multiple sensing elements.

In a preferred embodiment, the sensing circuit 312 is directly bonded to the traces 308 of the electrochemical cell via metal interconnects 313 such as solder, silver, or gold in a flip-chip configuration. In such schemes, a dielectric underfill 314 may be optionally dispensed between the sensing circuit 312 and the body 300 of the cell. The sensing circuit 312 may alternatively be attached to the traces 308 of the cell via an anisotropic conducting paste (ACP) or anisotropic conducting film (ACF). The sensing circuit 312 may alternatively be physically attached to the body 300 of the cell via a die attach epoxy. Electrical connection to the traces 308 on the cell may then be performed by wire bonding. The sensing circuit 312 and the wirebonds may then be protected by an epoxy or silicone overmold or dam and fill process.

Additional traces are integrated into the electrochemical cell to allow electrical interconnection to the sensing circuit 312 from the application substrate (e.g., a printed circuit board) by means of ACF, ACP, spring-clips, connector contacts, solder, or any other appropriate electrical interconnection schemes. In a preferred embodiment, these traces are terminated in solder balls 315 to allow direct reflow of the component on to solder pads of the application substrate.

During reflow of the solder balls 315 to solder pads on the application substrate 321 (FIG. 2) or other attach processing of the electrochemical cell to the application substrate 321, chemical fumes may be emitted during the processing. These fumes may adsorb onto the surface of the electrodes 302/303/322 thereby resulting in electrode poisoning, further resulting in desensitization or de-calibration of the electrochemical cell. So as to counter this effect, driving current in one instantiation may be applied to the cell by the circuit 312 after processing to enable desorption of such fumes or their by-products from the electrodes 302/303/322, thereby rendering the cell back to its original state or close thereto. Alternatively, as shown in FIG. 2, a temporary protective cover 320 may be attached over the opening 306 in the electrochemical cell 290 prior to processing to inhibit the passage of such fumes to the electrodes 302/303/322 in the first place, said cover 320 being removed after processing. In this scheme, any optional filter 307 (FIG. 1) may be applied after attachment to the application substrate 321.

FIG. 3 is an exploded view of the sensor module 290 showing the filter 307, lid 301 (with gas openings), working electrode 302, counter electrode 303, reference electrode 322, electrolyte 304 (which may be a gel), ceramic body 300, sensor circuit 312, and solder balls 315 for attachment to a printed circuit board (PCB). The solder balls 315 electrically connect leads from the sensor circuit 312 to the PCB and include power terminals, control terminals, and output terminals. The output data from the sensor circuit 312 may be digital and may comprise the data relating to the gas detection (based on the currents through the electrodes), as well as temperature, humidity, air pressure, etc. The PCB may contain communication components for conveying the data to a remote central processor controlling a network of dispersed sensor modules.

In one embodiment, the size of the sensor module 290 is about 4 mm×4 mm×1.8 mm (height). The small size of the sensor results in many advantages including a fast response to a gas. This enables the sensor to be used as a breathalyzer where telltale gases in a person's breath correspond with alcohol consumption or other physical characteristics.

Various advantages of the sensor module 290 include the following:
Low volatility electrolytes (“stable to atmospheric condition”) resulting in
   Limited evaporation or absorption of water over life, resulting in
      A smaller reservoir of electrolyte being required for a given product lifetime and set of operating conditions, resulting in
         A reduced product footprint.
   PPM level (or no) water composition being needed in the electrolyte (especially in the case of zwitterionic electrolytes) for operation resulting in
      A smaller reservoir of electrolyte being required for a given product lifetime and set of operating conditions, resulting in
         A reduced product footprint.
   The ability for the electrolyte to be processed at elevated temperatures, resulting in
      The ability to leverage standard high volume semiconductor assembly processes, resulting in
         Cost reduction (no custom processes required).
         OEM Customer Ease of Use and cost reduction, such as assembly via standard solder reflow assembly of components on PCB.
A small sized sensor results in
   Feasibility of incorporation into cellphone and consumer electronics form factors, resulting in
      Enabling high-volume markets, resulting in
         Manufacturing scale, resulting in cost reductions.
      The ability to leverage existing cellphone infrastructure (processor, I/O, etc.) resulting in
         System cost reduction (vs making a stand-alone system)
   Reduced capacitance of the cell, resulting in
      Faster response of the cell, resulting in
         Enablement of gas spectrometry with electrochemical cells with compact, low voltage and current
         Improved user experience
         Facilitating time-critical applications such as breath-analysis
Sensors incorporated into mobile devices or dispersed in compact sensor nodes enables the ability to map gas concentrations in areas, further resulting in
   The potential provision of local air quality around a person vs general, non-user specific AQI reading generated through a weather station miles away
   The ability to identify sources of pollution—vehicles needing to be smog checked for example
   The ability to highlight that a parking garage is in need of better aeration.
   The application of contextual data (location, user' s activity, time of day, time of year, humidity, temperature, ambient uv light, etc.) taken from the sensor, phone, or the network to the interpretation of the sensor data, resulting in
      Increased accuracy of the interpretation of the data. E.g., you can compensate the raw sensor data for ambient humidity and temperature
      The ability to accurately extrapolate, by statistics, the existence of other environmental factors not directly measured by the sensor. E.g., if you are indoors at home and measuring CO, there are known likely correlations to the presence of particulates (soot) in the local environment since both have the same root cause—e.g. incomplete combustion of gas, wood, etc.
   Several sensor nodes distributed through a vehicle cabin or in a conference room can not only determine room/cabin occupancy (through monitoring for example CO or CO2 levels in the room), but also positions of individuals as well as monitor health of individuals near the individual sensors (increase in hydrogen near the kids during a car trip indicating oncoming nausea and motion sickness for example)
   The networking of sensors resulting in ease of ongoing calibration via a cross-calibration scheme.

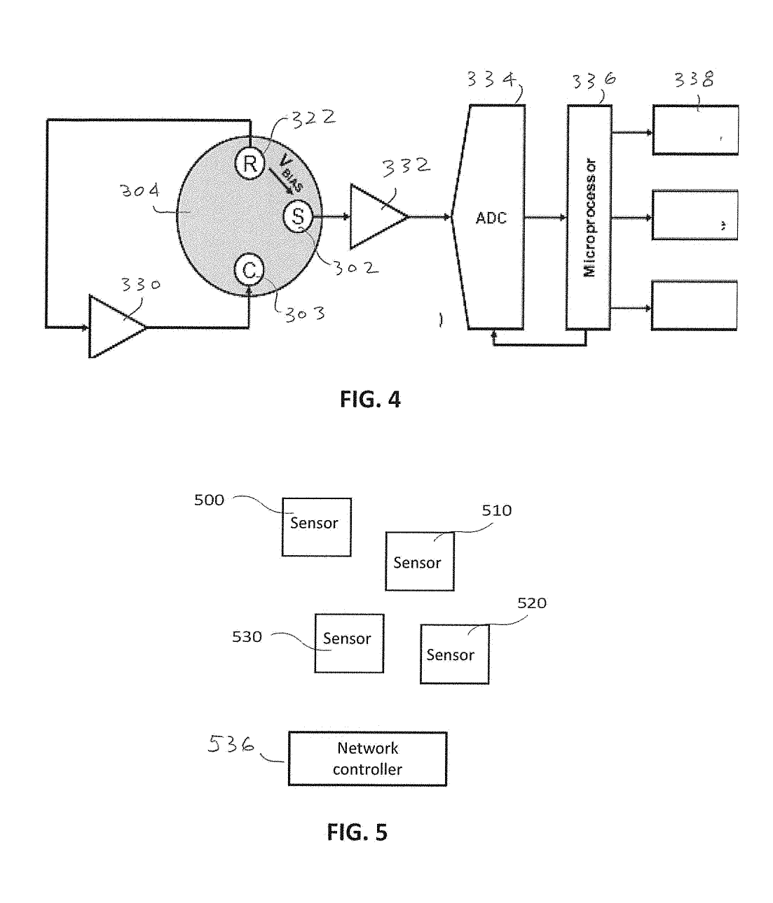

FIG. 4 illustrates one of the many possible biasing schemes for the working electrode 302, the counter electrode 303, and the reference electrode 322 within the electrolyte 304. The top surface of the porous working electrode 302 is subjected to the gas, and the bottom surface of the working electrode 302 is within the electrolyte 304 or otherwise in intimate contact with the electrolyte. The gas contacts the electrolyte 304 through the porous working electrode 302 at an interface, effecting a chemical reaction that releases or absorbs electrons, creating a current proportional to the gas concentration.

FIG. 4 also shows circuitry for detecting the working electrode 302 current (characteristic of a target gas) and digital processing techniques for outputting data relating to the detected gas. The circuitry is located in the sensor circuit 312 (FIG. 1). The circuitry shown in FIG. 4 is a well-known generic circuit for biasing electrochemical cells. Special biasing schemes may be used to target different gasses.

A potentiostat circuit, which may be powered, for example, by an op-amp, manages the potential between the working electrode 302 and counter electrode 303 so as to allow completion of the electrochemical circuit, and for current generated at the working electrode 302 to flow through the circuit. An input reference voltage, which may be fixed or a settable control voltage, sets a desired bias between the working electrode 302 and the reference electrode 322. The reference electrode 322 (protected from the gas) provides a stable electrochemical potential in the electrolyte 304. The bias voltage can be zero, positive, or negative and will typically be within 500 mV. The current flow through the working electrode 302 is converted to a voltage by a transconductance amplifier 332. The analog output of the amplifier 332 is converted to a digital signal by an analog-to-digital converter 334. The digital signal is then processed by a microprocessor 336. The microprocessor 336 then outputs data to various registers 338 for communicating to a central network.

An array of electrochemical cells may be employed for detecting different types of gasses. A single electrochemical cell may have a footprint of less than 5 mm×5 mm, so the footprint of the array may scale linearly or sub-linearly with shared components. For example, a single processor may process the data for all cells. In one example, a first cell might comprise a first electrolyte—catalyst/electrode combination optimized to detect a first set of gasses, and a second cell might comprise a second electrolyte optimized to detect a second set of gasses.

At the point of manufacture or deployment, sensors and sensing systems typically require calibration. Over time, the calibration of many sensors tends to drift. Accordingly, many precision sensing systems require periodic ongoing calibration after initial exposure to the atmosphere up until the end of the system operating life. Depending on the sensor type, periodic calibration may be required, for example, every six or twelve months. Such periodic calibration can be time consuming, costly, and inconvenient to the user. Accordingly, we propose here a scheme in which a network of deployed gas or other environmental sensors can be calibrated on an ongoing basis in a convenient manner.

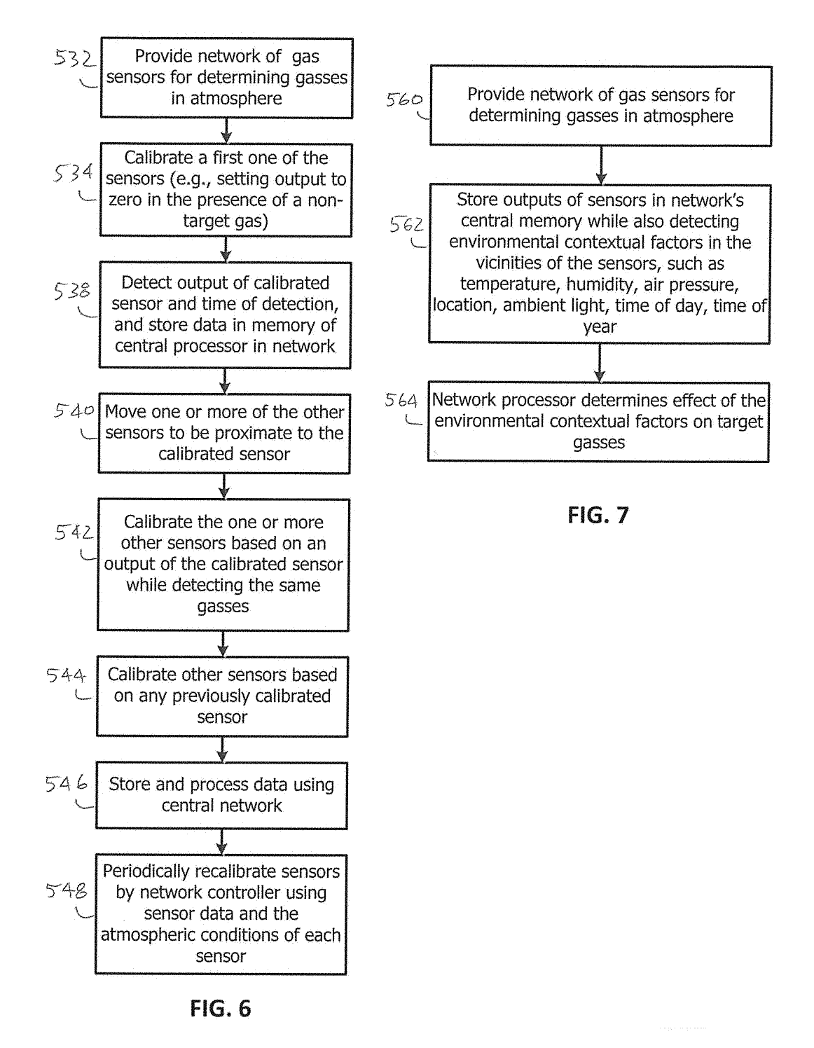

In this scheme, as shown in FIG. 5 and the flowchart of FIG. 6, a geographical region comprises a network of environmental sensors 500, 510, 520, and 530 (step 532) of known geographical location, at least one of which (sensor 500) is known to be in calibration (step 534). The known in-calibration sensor 500 may be, for example, a recently calibrated consumer sensor, or a professionally-maintained sensor such as a fixed air quality index (AQI) sensing station maintained, for example, by the Environmental Protection Agency or any other technical, commercial, academic, or governmental agency. The time at which the sensors measure the environment, as well as the results of the measurement, is recorded by either the individual sensing systems or a central memory in a central network controller 536 (step 538). As a mobile environmental sensor 510 in that network comes into close geographical proximity to the known in-calibration sensor 500, the mobile sensor 510 may sense the local environment and compare the reading taken with that reported by the known in-calibration sensor 500 at approximately the same time, and use the reported data to recalibrate itself (steps 540 and 542).

As the mobile sensor 510 then comes into close proximity with a second fixed or mobile sensor 520 on the network, readings from the two sensors from approximately the same time can be compared so that the calibration of the sensors can be improved. For example, if sensor 510 is known to have been more recently calibrated against a known, in-calibration sensor 500, and sensor 520 has not recently been calibrated, the calibration of sensor 520 may be updated against that of sensor 510 or vice-versa (step 544).

Alternatively, as a less-well calibrated sensor 520 comes sequentially into close geographic proximity with recently calibrated sensors 500/510/530, the sensor 520 can compare its readings with each of the readings from sensors 500/510/530 and can calibrate to a most statistically significant state as determined by an analysis of the readings of the polled networks sensors 510/520/530.

The various calibrated sensors may then be used to collect data in any location, and the data is stored and further processed by the network controller 536 (step 546).

By extrapolation, data from a plurality of the networked sensors may be analyzed centrally by the network controller 536 or by an agent so that a detailed map of atmospheric conditions may be compiled. Communications with the network controller 536 may be by RF, the Internet, or any other means. All networked sensors may then be remotely re-calibrated by the network controller 536 on an ongoing basis against this map (step 548). The local resolution of this map may be further improved by extrapolating knowledge of local sources of gasses, particulates, and other atmospheric pollutants such as factories or work sites, traffic, and prevailing weather conditions such as wind, rain, and temperature.

FIG. 6 is a flowchart relating to determining the effects of different environmental conditions on a target gas. The various sensors in the network may, in conjunction with transmitting data regarding the target gasses, also transmit its surrounding environmental conditions, such as temperature, humidity, air pressure, etc., to the network controller 536 (steps 560 and 562). The environmental condition sensors may be separate from the electrochemical sensor module. A processor in the network controller 536 may then determine the effects of the different environmental conditions on the various sensors and target gasses (step 564).

Having described the invention in detail, those skilled in the art will appreciate that, given the present disclosure, modifications may be made to the invention without departing from the spirit of the inventive concepts described herein. Therefore, it is not intended that the scope of the invention be limited to the specific embodiments illustrated and described.

For example, the ongoing calibration scheme described is applicable to other environmental sensors such as particulate sensors and ambient light sensors; the ongoing calibration scheme may optionally be performed by manually comparing the readings of two or more sensors having close geographic proximity; one or more of the sensing circuit and the external electrodes on the sensing module may be placed on the lid of the sensing module; the sensing module may comprise multiple electrochemical cells, each cell having a unique combination of electrodes and electrolyte so as to improve the selectivity and range of gasses which can be detected; and the sensing module may comprise one or more additional environmental sensing elements such as humidity sensors, temperature sensors, pressure sensors, metal oxide gas sensors, chemi-resistive sensors, particulate sensors, and optical sensors.

While particular embodiments of the present invention have been shown and described, it will be obvious to those skilled in the art that changes and modifications may be made without departing from this invention in its broader aspects and, therefore, the appended claims are to encompass within their scope all such changes and modifications that are within the true spirit and scope of this invention.

What is claimed is:

1. An electrochemical gas sensing element comprising:
a package body containing a partly-enclosed cavity;
an electrolyte contained within the cavity;
a plurality of electrodes on the inside of the partly-enclosed cavity, the electrodes being in contact with the electrolyte;
a gas opening in the package body for allowing a gas to contact at least one of the electrodes;
electrical interconnects leading from the electrodes to outside the cavity; and
a plurality of electrical contacts on an outer surface of the package body for receiving power and for outputting information related to a detected gas,
wherein the package, electrolyte, and electrodes are formed of materials that withstand processing temperatures of greater than 180° C.

2. The gas sensing element of claim 1 wherein the package body comprises a ceramic material.

3. The gas sensing element of claim 1 wherein the electrolyte is physically and chemically stable with processing temperatures up to 260° C.

4. The gas sensing element of claim 1 wherein the electrolyte comprises a zwitterionic material.

5. The gas sensing element of claim 1 wherein the electrolyte comprises a polymer infused with an acid.

6. The gas sensing element of claim 1 wherein the electrolytes are physically and chemically stable with processing temperatures up to 260° C.

7. The gas sensing element of claim 1 wherein the electrical interconnects are formed along an outside of the package body.

8. The gas sensing element of claim 1 wherein a portion of the electrical interconnects is shielded from electromagnetic interference.

9. The gas sensing element of claim 1 further comprising:
a sensor circuit affixed to the package body, the sensor circuit detecting a current through at least a first electrode corresponding to a concentration of gas impinging on the first electrode, the sensor circuit being configured to process the current and output digital data to the plurality of electrical contacts.

10. The gas sensing element of claim 9 wherein the sensor circuit includes an analog-to-digital converter and a processor for generating the digital data relating to a gas detected by the gas sensing element.

11. The gas sensing element of claim 10 wherein the sensor circuit comprises an Application Specific Integrated Circuit (ASIC).

12. The gas sensing element of claim 9 wherein the sensor circuit further comprises a temperature sensor that detects a temperature of the gas sensing element.

13. The gas sensing element of claim 9 wherein the sensor circuit further comprises a humidity sensor.

14. The gas sensing element of claim 9 wherein the sensor circuit further comprises an air pressure sensor.

15. The gas sensing element of claim 1 wherein the electrical contacts comprise solder balls configured to be reflowed to electrically contact solder pads on a substrate.

16. The gas sensing element of claim 1 wherein the gas sensing element has a footprint of less than 5 mm×5 mm.

17. A method of sensing a gas using a network of spaced electrochemical gas sensors comprising:
calibrating a first gas sensor;
moving one or more other sensors proximate to the first sensor while detecting a target gas;
comparing output data from the first sensor and the one or more other sensors; and
calibrating the one or more other sensors based on the output data of the first sensor.

18. The method of claim 17 wherein the step of calibrating the first gas sensor comprises calibrating a magnitude of one or more electrochemical currents generated by the first gas sensor against a concentration of one or more gasses being detected by the first sensor.

19. The method of claim 17 further comprising measuring one or more environmental factors and accounting for their impact on the output data from the network of gas sensors.

20. The method of claim 19 wherein the one or more environmental factors comprise one or more of temperature, humidity, pressure, location, ambient lighting, time of day, and time of year.

21. The method of claim 17 further comprising cross-calibrating any one of the gas sensors with other ones of the gas sensors based on comparing the output data of the calibrated first gas sensor in a certain location and at a certain time with output data of one or more uncalibrated second gas sensors proximate to the certain location and approximately at the certain time, and calibrating the second gas sensors to output data similar to the output data of the first gas sensor.

22. A method of inferring an effect of overall local atmospheric conditions on detected gasses comprising:
sensing one or more gasses by a first gas sensor in a first location and outputting data from the first gas sensor corresponding to sensed one or more gasses;
ascertaining additional local environmental data from additional localized sensors; and
applying known correlations between the sensed one or more gasses and the local environmental data to determine the overall local atmospheric conditions.
